(19) United States
(12) Patent Application Publication
(10) Pub. No.: US 2026/0112655 A1
(43) Pub. Date: Apr. 23, 2026

(54) ATOMICALLY DISPERSED NIOBIUM-BASED ELECTROCATALYSTS FOR METAL-AIR BATTERIES

(71) Applicants: Arizona Board of Regents on Behalf of Arizona State University, Scottsdale, AZ (US); University of Oklahoma, Norman, OK (US)

(72) Inventors: Zhaoyang FAN, Phoenix, AZ (US); Xueyan LIN, Tempe, AZ (US); Bin WANG, Norman, OK (US)

(21) Appl. No.: 19/366,390

(22) Filed: Oct. 22, 2025

Related U.S. Application Data
(60) Provisional application No. 63/710,535, filed on Oct. 22, 2024.

(51) Int. Cl. H01M 4/90; H01M 4/86; H01M 6/04

(52) U.S. Cl. CPC H01M 4/9016; H01M 4/8615; H01M 4/8626; H01M 4/9083; H01M 6/045; H01M 2004/8689

(57) ABSTRACT

A catalyst for a metal-air battery includes a nitrogen-doped graphitic carbon support and atomically dispersed niobium atoms disposed on the nitrogen-doped graphitic carbon support. A positive electrode for a metal-air battery includes a catalyst coated layer comprising niobium atoms and a nitrogen-doped graphitic carbon support. The niobium atoms are atomically dispersed on the nitrogen-doped graphitic carbon support. A metal-air battery includes an negative electrode, an electrolyte, and a positive electrode. The positive electrode includes a catalyst coated layer that includes niobium atoms and a nitrogen-doped graphitic carbon support. The niobium atoms are atomically dispersed on the nitrogen-doped graphitic carbon support.

### RELATED APPLICATIONS

This application claims the benefit of U.S. provisional patent application 63/710,535, filed Oct. 22, 2024, to Zhaoyang Fan et al., titled “ATOMICALLY DISPERSED NIOBIUM-BASED ELECTROCATALYSTS FOR METAL-AIR BATTERIES,” the entirety of the disclosure of which is hereby incorporated by this reference.

### STATEMENT REGARDING FEDERALLY SPONSORED RESEARCH OR DEVELOPMENT

This invention was made with government support under 2129983 awarded by the National Science Foundation. The government has certain rights in the invention.

### TECHNICAL FIELD

This document relates to metal-air batteries having niobium-based atomically distributed electrocatalysts.

### BACKGROUND

Metal-air batteries are an emerging technology recognized for their high energy density, cost-effectiveness, and environmentally friendly properties, along with the ability to be recharged. These batteries operate by utilizing a metal (e.g., zinc) as the anode and oxygen from ambient air as the cathode reactant, offering significant advantages over traditional battery systems while also offering enhanced safety through the use of air as the cathode reactant.

Despite their potential, widespread adoption of metal-air batteries has been hindered by several technical challenges, particularly the efficiency, cost, and durability of the air cathode.

### SUMMARY

The present disclosure relates to a metal-air battery including: an negative electrode; an electrolyte, and a positive electrode including a catalyst coated layer comprising niobium atoms and a nitrogen-doped graphitic carbon support, wherein the niobium atoms are atomically dispersed on the nitrogen-doped graphitic carbon support.

Particular embodiments may comprise one or more of the following features. At least half of the nitrogen-doped graphitic carbon support comprises a single graphene layer. At least a portion of the catalyst coated layer further includes clusters of more than one niobium atom disposed on the nitrogen-doped graphitic carbon support, wherein the clusters are 20 nanometers (nm) or less in size. The niobium atoms may be bonded to nitrogen atoms within the nitrogen-doped graphitic carbon support. The nitrogen-doped graphitic carbon support further includes oxygen atoms bonded to the niobium atoms. The nitrogen-doped graphitic carbon support exhibits a hierarchical porous structure. The catalyst coated layer is configured to catalyze both oxygen reduction reactions (ORR) and oxygen evolution reactions (OER). The negative electrode comprises zinc, iron, magnesium, aluminum, or lithium. The electrolyte comprises an alkaline electrolyte. The electrolyte comprises KOH. The nitrogen-doped graphitic carbon support includes a nitrogen atom concentration which is substantially the same as a carbon atom concentration. An area on the graphitic carbon support comprising atomically dispersed niobium atoms is greater than an area on the graphitic carbon support comprising clusters of more than one niobium atom.

The present disclosure relates to a positive electrode for a metal-air battery, the positive electrode including: a catalyst coated layer comprising niobium atoms and a nitrogen-doped graphitic carbon support, wherein the niobium atoms are atomically dispersed on the nitrogen-doped graphitic carbon support.

Particular embodiments may comprise one or more of the following features. At least a portion of the catalyst coated layer comprises clusters of more than one niobium atom dispersed on the nitrogen-doped graphitic carbon support, wherein the clusters are 20 nanometers (nm) or less in size. A surface area of the graphitic carbon support comprising atomically dispersed niobium atoms is greater than a surface area of the graphitic carbon support comprising clusters of more than one niobium atom. The niobium atoms are bonded to nitrogen sites within the nitrogen-doped graphitic carbon support. The catalyst coated layer catalyzes both oxygen reduction reactions (ORR) and oxygen evolution reactions (OER). A nitrogen atom concentration is substantially the same as a carbon atom concentration in the nitrogen-doped graphitic carbon support. The niobium atoms are in a fixed location on the nitrogen-doped graphitic carbon support. The nitrogen-doped graphitic carbon support comprises polymeric carbon nitride (PCN).

The present disclosure relates to an electrode for a metal-air battery, the electrode including: a gas diffusion layer; a current collector, and a catalyst coated layer, wherein the catalyst coated layer comprises a nitrogen-doped graphitic carbon support and atomically dispersed niobium atoms disposed on at least a portion of a surface of the nitrogen-doped graphitic support.

The foregoing and other aspects, features, and advantages will be apparent from the DESCRIPTION and DRAWINGS, and from the CLAIMS.

### BRIEF DESCRIPTION OF THE DRAWINGS

Implementations will hereinafter be described in conjunction with the appended and/or included DRAWINGS, where like designations denote like elements, and:

FIG. 1 is a representation of a metal-air battery according to some embodiments;

FIG. 2 is a representation of a method of forming a catalyst;

FIG. 3 is a representation of a catalyst according to some embodiments;

FIGS. 4a-c are test results for a metal-air battery catalyst;

FIGS. 5a-b are test results for a metal-air battery catalyst;

FIGS. 6a-e are test results for a metal-air battery catalyst;

FIGS. 7a-g are test results for a metal-air battery catalyst;

FIGS. 8a-f are test results for a metal-air battery catalyst;

FIGS. 9a-d are test results for a metal-air battery catalyst;

FIG. 10 is a representation of a metal-air battery according to some embodiments; and

FIGS. 11a-d are test results for a metal-air battery catalyst.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure relates to advancements in metal-air (or metal-O₂) batteries by incorporating a positive electrode catalyst which is based on atomically dispersed Nb atoms on a nitrogen doped (N-doped) graphitic carbon support. The material has the ability to catalyze oxygen reduction reactions (ORR), oxygen evolution reactions (OER), and hydrogen evolution reactions (HER), and other reactions. Therefore, it can be used as an electrocatalyst in various metal-air (oxygen) batteries, water electrolysis, fuel cells, and other settings. When used as a catalyst in air positive electrodes as part of metal-air batteries, it can be applied to Fe-air, Mg-air, Al-air, Li-air and many other metal-air batteries that involve ORR and OER. While the examples following focus on zinc-air batteries, the disclosed positive electrode catalyst and graphitic carbon support may be useful in metal-air batteries comprising other negative electrodes besides zinc.

Metal-air batteries, such as Zinc-air batteries (ZABs), are an emerging technology recognized for their high energy density, cost-effectiveness, and environmentally friendly properties. These batteries operate by utilizing zinc as the negative electrode and oxygen from ambient air as the positive electrode reactant, offering significant advantages over traditional battery systems. Despite their potential, widespread adoption of metal-air batteries, including ZABs, have been hindered by several technical challenges, particularly the efficiency, cost, and durability of the air positive electrode. While ZABs are primarily discussed herein, a person of ordinary skill in the art would understand that the principles may be applied with other metal-air batteries comprising other negative electrodes, such as negative electrodes comprising iron (Fe), magnesium (Mg), potassium (K), sodium (Na), aluminum (Al), or lithium (Li), and alloys formed therefrom. The negative electrodes may comprise a single crystal of the above referenced metals, or they may be polycrystalline and may have various dopants, such as manganese or nickel added to enhance structural or electrical properties.

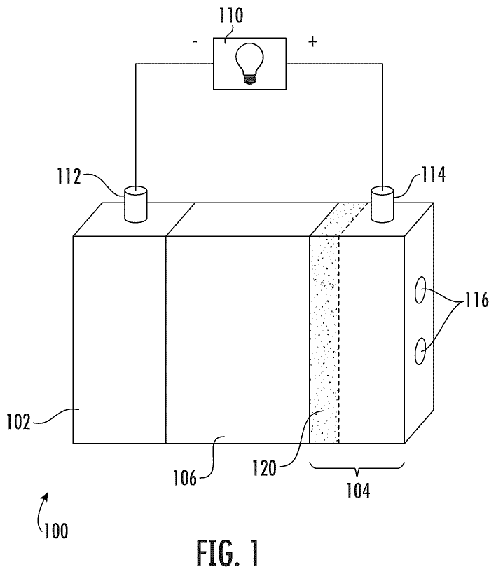

FIG. 1 depicts various embodiments of a cross-sectional view of a metal-air battery, such as a zinc-air battery. ZAB 100 includes an negative electrode 102, a positive electrode 104, an electrolyte 106, and at least one air hole 116 to allow air into the positive electrode 104. ZAB 100 can power a device 110 connected to negative electrode terminal 112 and positive electrode terminal 114. If ZAB 100 is implemented as a secondary battery, ZAB 100 can discharge energy to supply device 110 or, alternatively, device 110 can charge ZAB 100. During discharge of ZAB 100, O₂ at the air-electrode (positive electrode 104, positively charged during discharge) is reduced into OH⁻ in the oxygen reduction reaction (hereinafter referred to as ORR). During charge of ZAB 100, OH⁻ is oxidized at the air-electrode (positive elctrode 104, positively charged during charging) in the oxygen evolution reaction (hereinafter referred to as OER). Since ORR and OER take place at the same positive electrode 104 (air electrode) and both reactions are kinetically slow, a catalyst 120 may be included in positive electrode 104, especially a catalyst that is effective for both ORR and OER. Finding such a catalyst, with high reaction kinetics for both ORR and OER, in a single material has proven challenging. One option is to use a mixture of Pt-based and IrO₂-based catalysts. Pt-based catalyst (e.g. Pt/C) is effective for ORR, while IrO₂-based (e.g. IrO₂/C) is effective for OER. However, both are precious metals from the Pt-group elements (PGE) with high cost. Further, combining two precious metals in the positive electrode 104 (air electrode) and balancing the rates of ORR and OER for each metal increases manufacturing complexity. Their activities and stability in OER and ORR also require further improvement.

This disclosure addresses these challenges by introducing an enhanced ZAB 100 design featuring an air-electrode catalyst 120 in positive electrode 104 that significantly improves ORR and OER efficiency and its durability, thereby extending the performance and lifespan of ZAB 100 (catalyst 120 is also referred to as niobium-based atomically dispersed catalyst 120, Nb—N—C catalyst 120, Nb—N—C 120, atomically dispersed catalyst 120, or ADC 120). In some embodiments, the air-electrode catalyst 120 comprises a catalyst based on Niobium (Nb). In some embodiments, the catalyst 120 is an atomically dispersed Nb-based catalyst. The atomically dispersed catalyst 120 (or atomic scale catalyst) may include a single atom (e.g., Nb) or several atoms formed as a loose cluster dispersed on a porous structure. The Nb-based, atomically dispersed catalyst 120 (referred to herein as “ADC”) is bifunctional, in that it catalyzes both ORR and OER efficiently. A niobium-based atomically dispersed catalyst 120 is based on Nb, a non-precious metal group transition metal with low cost. And due to Niobium's atomic dispersion and extreme atom-utilization efficiency, only a tiny amount of Nb is used in various embodiments. The disclosure enables the use of Zn-air batteries 100 (and other metal-air batteries) across a broad range of applications, providing a sustainable and efficient energy solution.

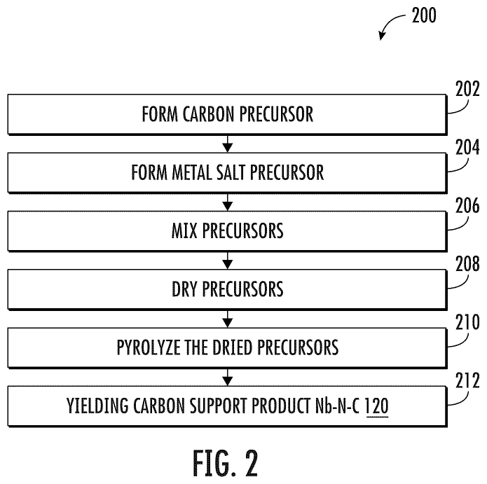

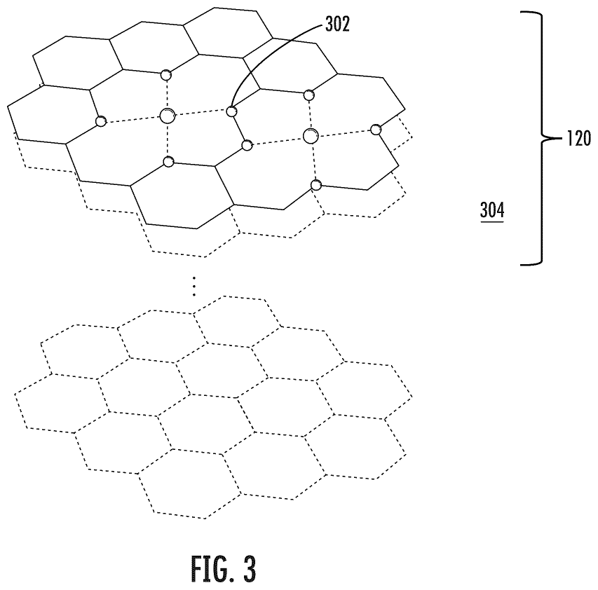

FIG. 2 describes a synthesis process 200 for atomically dispersed catalyst 120 used in positive electrode 104, and partially depicted in FIG. 3. In some embodiments, the niobium-based atomically dispersed catalyst 120 is synthesized 200 using a controlled process involving impregnation and pyrolysis. As part of the impregnation process, the method 200 includes forming a carbon precursor 202. For example, this may be done by dissolving glucose in ethanol. As one example, 288 mg of glucose (C₆H₁₂O₆) may be dissolved in 80 ml of ethanol. While glucose and ethanol are used according to this embodiment, other carbon sources and other alcohols may be used and are within the scope of the disclosure. The method 200 further includes forming a metal salt precursor 204. For example, the metal salt precursor may be formed by ultrasonically dissolving Niobium (V) chloride (NbCl₅) with hydroxylamine hydrochloride ((NH₃OH)Cl) in deionized water. As one example 10 mg of Niobium (V) chloride (NbCl₅) with 1.38 g of hydroxylamine hydrochloride ((NH₃OH)Cl) may be ultrasonically dissolved in 80 ml of deionized water. In some embodiments, other hydrochloric acid and similar salts may be used. Further, other salts of niobium may be used in addition to Niobium (V) chloride. The carbon precursor 202 and metal salt precursor 204 solutions are mixed 206 and dried 208. For example, the carbon 202 and metal salt 204 precursor solutions may be dried 208 in an oven under ambient air at 70° C. for 12 hours to remove solvents and facilitate the formation of a stable precursor material. Various combinations of time (e.g., up to about 15 hours) and temperatures (e.g., up to about 100° C.) may be used to facilitate drying 208 of the mixed precursor 206 material.

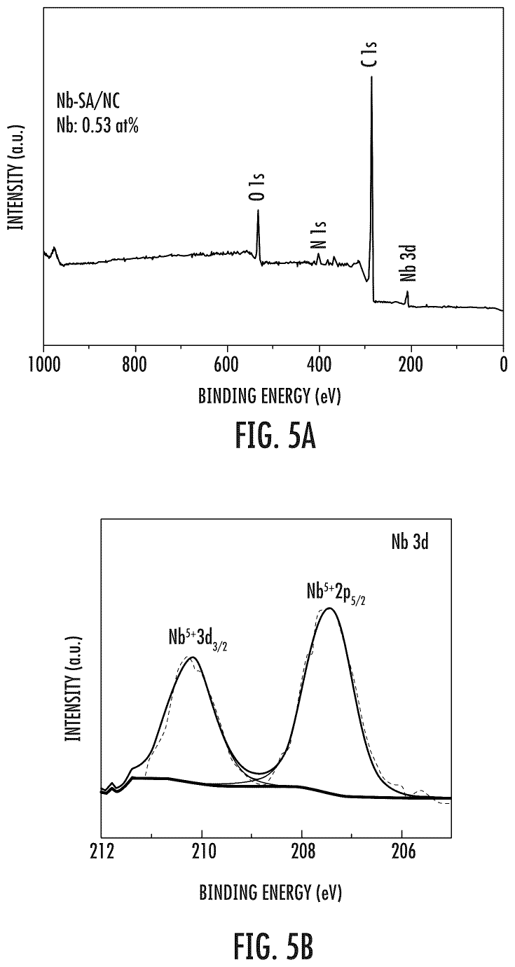

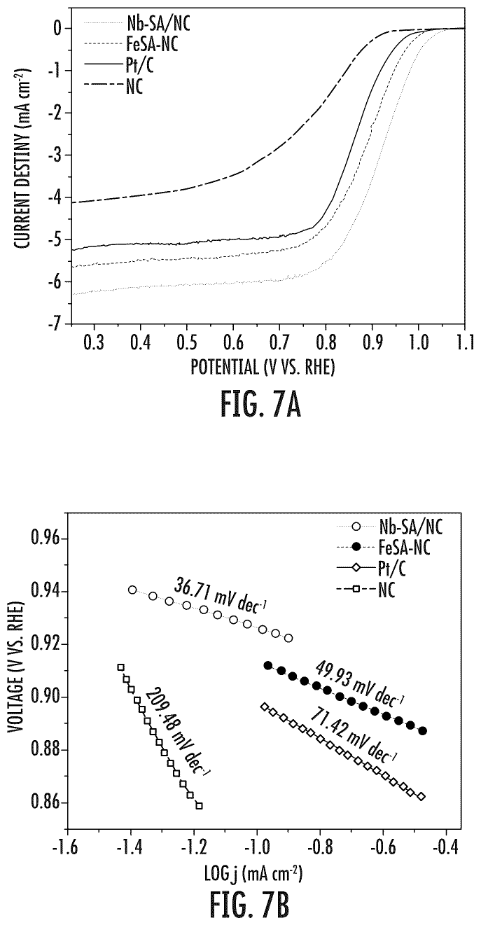

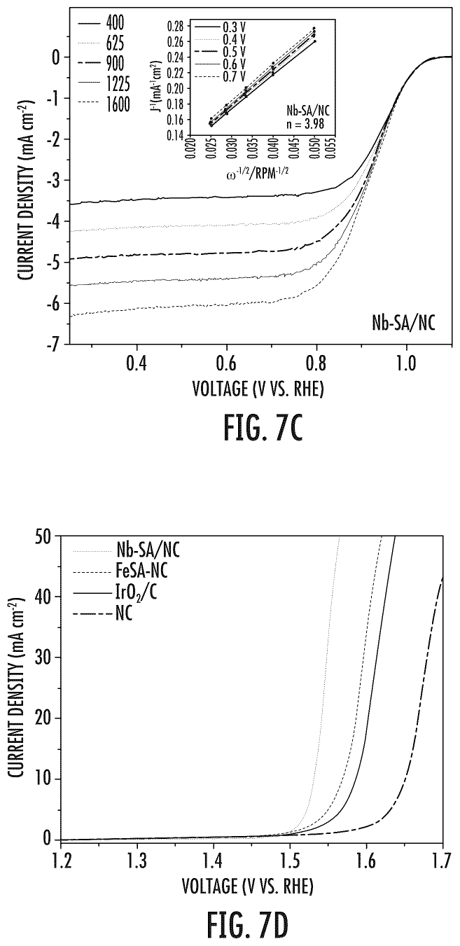

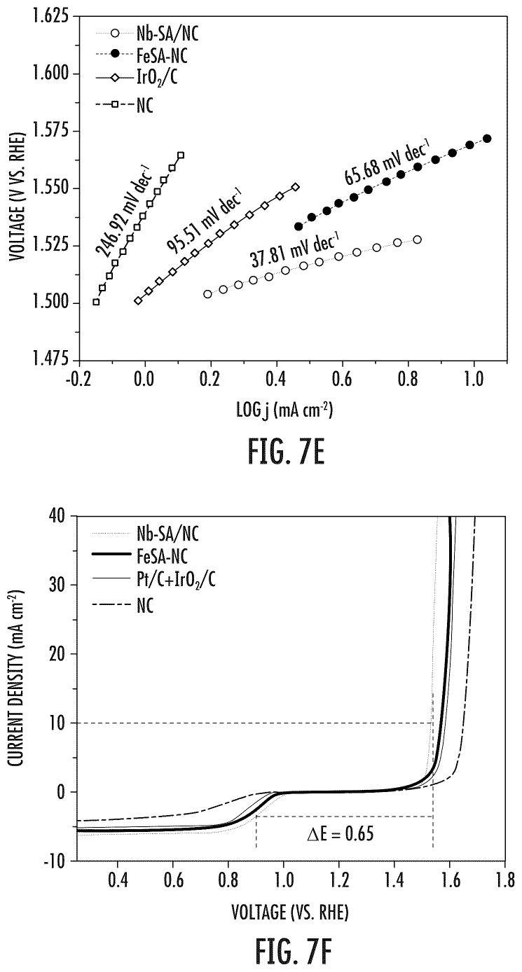

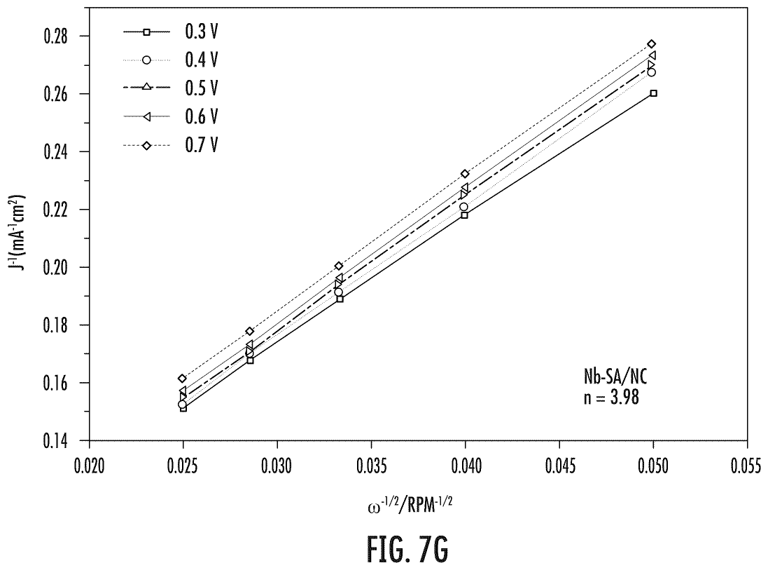

As part of the method 200 to form the niobium-based, atomically dispersed catalyst 120 (ADC), the pyrolysis process 210 includes transferring the dried 208 precursor material to a crucible and subjecting the precursor material 208 to pyrolysis 210. According to the pyrolysis process 210, the temperature may be gradually increased from room temperature to 600° C. at a rate of from 3° C./minute to 10° C./minute, or about 5° C./minute under an argon (Ar) atmosphere. The precursor material 208 may be maintained at a pyrolysis temperature of about 600° C. for about 4 hours to complete the pyrolysis process 210. According to some embodiments of the pyrolysis method 210, a pyrolysis temperature of from about 500° C. to 650° C., or from about 550° C. to 600° C. may be used, with an exemplary duration of from 1 to 4 hours. The resulting powder 212 comprises atomically dispersed niobium atoms 302 anchored, e.g., disposed in a fixed location, to nitrogen sites on at least a portion of an N-doped graphitic carbon (NC) support 304, and is denoted as the niobium-based atomically dispersed catalyst ADC 120 (NC support 304 is also referred to as doped carbon support 304, NC support 304, NC powder(s) 304, and NC 304). In numerous embodiments, the N-doped graphitic carbon support 304 comprises a single layer of graphene instead of multiple layers of graphene as depicted in FIG. 3. In certain embodiments, the N-doped graphitic carbon support 304 comprises two or more layers of graphene as depicted in FIG. 3. In some embodiments, the targeted goal is a single layer of graphene for the N-doped graphitic carbon support 304 for part, most, or all of the ADC 120. The atomically dispersed catalyst 120 (ADC 120) may also be referred to as Nb—N—C catalyst 120, Nb—N—C catalyst, Nb—N—C 120 or as Nb-SA/NC 120 or Nb-SA/NC throughout this disclosure and as depicted in numerous Figures (e.g., FIGS. 5(a), 7(a)-(g), 8(a), 8(c)-(f), 9(a)-(d), 11(a)-(d), etc.). In some embodiments, the N-doped graphitic carbon (NC) support 304 further comprises oxygen atoms, in particular oxygen atoms remaining in those NC powders 304 prepared at lower pyrolysis temperatures. As such, the resulting powder 212 further comprises atomically dispersed niobium atoms anchored to oxygen sites, in addition to nitrogen sites, on at least a portion of the N-doped graphitic carbon (NC) support 304. In keeping with this, the ADC 120 as disclosed herein further comprises oxygen atoms bonded to niobium atoms 302 in ADC 120. Niobium atoms 302 will bond with other nonmetal atoms like nitrogen, carbon, or oxygen. With an N-doped graphitic support 304, Niobium atoms 302 frequently bond with a few nitrogen atoms. Niobium atoms 302 can also bond with oxygen atoms (e. g, oxygen introduced from the air) Thus, various different atomic structures are created (e.g., Nb—N(x)—C, O—Nb—N(x), etc.) as niobium atoms 302 bond with other atoms in the synthesis process 200 creating ADC 120 using N-doped graphitic support 304. In addition to the atomically dispersed niobium atoms 302, the ADC 120 may further comprise clusters of more than one metal Nb atom 302 (or, Nb clusters), and the clusters may grow into a few nanometers or even tens of nanometer particles. In some embodiments, the powder 212 consists of atomically dispersed niobium 302 and N-doped graphitic carbon NC 304, as well as oxygen atoms within the graphitic carbon NC 304 bonded to the atomically dispersed niobium 302 of the ADC 120.

The synthesized N-doped graphitic carbon support NC 304 as disclosed herein is prepared using the same procedure but without adding NbCl₅ salt. In some embodiments, in the synthesized N-doped graphitic carbon support NC 304, in addition to the nitrogen element, oxygen impurities generally also exist, as aforementioned. The concentration of these oxygen impurities depends on the precursor pyrolysis temperature and duration of the pyrolysis process. The atomically dispersed metal atoms (e.g., Nb 302) are considered to be anchored on the NC 304 through bonding formation between each atomically dispersed metal atom and its direct neighboring nitrogen element in the graphitic carbon support NC 304. Since oxygen atoms also exist in the low temperature synthesized carbon material, the bonding is also between metal atoms, such as niobium, and oxygen atoms.

At high temperatures, individual metal atoms have the tendency to diffuse on the carbon support NC 304 surface and aggregate into clusters and particles of more than one metal atom when they have sufficient thermal energy. When the carbonization temperature is high, the nitrogen impurities in the formed carbon support NC 304 may be reduced, while a high concentration of nitrogen in the carbon support NC 304 is critical to achieve a large ADC density in ADC 120. Therefore, it is advantageous if the pyrolysis (carbonization) process 210 temperature for the metal salt precursor is as low as possible. However, a low carbonization temperature is detrimental to electrical conductivity of the N doped graphitic carbon support NC 304, negatively impacting the electrocatalyst performance. To provide a positive electrode 104 for a metal-air battery (e.g., ZAB 100) comprising a graphitic carbon support (e.g., NC 304) having a high concentration of nitrogen atoms and high electrical conductivity, and to further provide a catalyst coated layer comprising a high concentration of niobium atoms (e.g., ADC 120), which are atomically dispersed 302 on the nitrogen-doped graphitic carbon support NC 304, a two-step method may be used.

In some embodiments, a two-step method to make the niobium based, atomically dispersed catalyst (ADC) 120 may be used to increase the metal atom density on a graphitic carbon support NC 304. The two-step method comprises synthesizing the N-doped graphitic carbon support (NC) 304 in a first process at a higher temperature, and subsequently synthesizing atomically dispersed metal atoms on the NC 304 at a lower temperature. When a nitrogen atom 302 concentration is comparable to, the same as, or substantially the same as, a carbon atom concentration in the NC 304, the material may be referred to as carbon nitride (CN), and most commonly, pyrolysis-derived carbon nitrides are called polymeric carbon nitrides (PCNs). The basic building block of PCNs may comprise a triazine (C₃N₃) or heptazine (C₆ N₇) ring, where carbon and nitrogen atoms form a cyclic structure. These rings can link together through C—N bonds to form an extended two-dimensional or three-dimensional network within the carbon support NC 304. As used herein, “about” or “substantially” means a percent difference less than or equal to 30% difference, 20% difference, 10% difference, or 5% difference.

Synthesizing Polymeric Carbon Nitrides (PCNs) typically involves thermal polymerization of nitrogen-rich precursors like melamine, dicyandiamide, urea, or cyanamide.

These precursors undergo condensation reactions when heated, leading to the formation of a polymeric network of carbon and nitrogen atoms. The method for PCN synthesis may comprise: 1) combining an amount of at least one precursor, including melamine, dicyandiamide, urea, or cyanamide, or a mixture thereof according to a molar ratio such as melamine and dicyandiamide (7:3 molar ratio); 2) loading the at least one precursor into a crucible covered with a lid to create a semi-closed environment (to maintain a slight pressure during polymerization); 3) heating the crucible in a tube furnace under an inert atmosphere (e.g., argon or nitrogen) at a ramp rate of 5-10° C./minute to raise the temperature to about 550-600° C. and 4) holding the temperature for about 2-4 hours; and 5) allowing the furnace to cool to room temperature naturally (e.g., passively, according to natural convection). The resulting yellow powder comprises polymeric carbon nitride (PCN).

The PCN can be further functionally modified by acid treatment. Typically, the obtained PCN powder is treated with 65 wt % nitric acid (HNO3) at 80° C. for 5-6 hours. This acid treatment can introduce oxygen-containing functional groups (e.g., —OH, —NO₂) onto the surface of the carbon nitride, which can improve its hydrophilic properties used in the aqueous electrolyte. Acid treatment can also remove impurities and create pores in the material, enhancing its surface area and reactivity. As a last treatment, the PCN is ultrasonically treated to achieve well-dispersed suspension and remove any agglomerations. The PCN is collected and dried to get a finely dispersed PCN powder. Use of PCN as the nitrogen-doped graphitic carbon support NC 304 provides for a high concentration of nitrogen sites for bonding of atomically dispersed niobium atoms 302 and high surface area for increased surface area of the atomically dispersed catalyst 120 coated layer. In embodiments where the PCN powder is functionally modified by acid treatment, the surface of the carbon nitride may further comprise oxygen-containing functional groups where the oxygen atoms in the PCN may subsequently bond with metal atoms, as described following.

Synthesis of Metal Impregnated NC 304:Nb—NC. According to the two-step method to make the niobium based, atomically dispersed catalyst (ADC) 120, an impregnation-pyrolysis method may be used with PCN as the NC 304 substrate (graphitic carbon support) for the synthesis. A niobium-based metal salt may be selected as the metal precursor that decomposes at a lower pyrolysis temperature than the pyrolysis temperature of the NC 304 and the PCN (without inclusion of a metal atom), such as from about 350° C. to about 550° C., or from about 400° C. to about 500° C., to isolate the metal atoms from the other elements through vaporization. According to the two-step method, for a desired metal impregnated NC 304 comprising Nb, niobium oxalate, which is a complex of niobium with oxalate anions (C₂O₄²⁻) , having a pyrolysis temperature of about 400° C. may be selected. However, according to additional embodiments, different salts of Nb having a similar or same pyrolysis temperature of from about 350° C. to about 525° C., or from about 400° C. to about 500° C. may be used. According to one embodiment, 2.5 g of PCN is added to 50 ml of a 0.10-0.15 mol/L niobium oxalate solution to make a suspension, which is treated by ultrasonic energy sufficient for the solution to become homogeneous with the PCN powder uniformly dispersed in the solution. The suspension may be aged at room temperature for from 1 to 4 hours, or about 2 hours, and then dried at 80° C. overnight to form a metal impregnated NC powder (Nb—NC powder). The well-impregnated Nb—NC powder may be loaded in a tube furnace. In some embodiments, after purging with N₂ or Ar, the tube furnace is pumped down to a low pressure of about 1 millitorr. The furnace temperature is increased from room temperature to the desired pyrolysis temperature. For example, in some embodiments for niobium oxalate a pyrolysis temperature of about 400° C. may be selected, at a rate of 5° C./min in vacuum. Then pyrolysis under vacuum conditions at about 400° C. may be performed for a duration of from about 1 hour to about 3 hours, or about 1 hour. A black powder comprising ADC 120 was obtained. The pyrolysis temperature should be high enough to decompose (reduce) Nb precursor to Nb metal atom. But high pyrolysis temperatures tend to cause increased density of Nb atom clusters instead of single Nb atoms 302. Pyrolysis in H₂ ambient can decrease the precursor reduction temperature. In some embodiments, pyrolysis in H₂ ambient is utilized to seek fewer Nb clusters with a lower pyrolysis temperature. A person of ordinary skill in the art (POSA) would understand that other niobium salts than those comprising oxalate, having different pyrolysis temperatures yet within the ranges as disclosed, may be used. Use of the disclosed two step method provides for lower pyrolysis temperatures applied to the Nb based ADC catalyst 120, thereby retaining the Nb atoms present on at least a portion of the carbon support NC 304 surface as atomically dispersed atoms 302 or forming aggregates, clusters or particles of more than one metal atom. The lower pyrolysis temperatures also result in a Nb based, ADC catalyst 120 comprising an NC 304 substrate (graphitic carbon support) having oxygen atoms disposed therein which are bonded to Nb in a similar manner as the bonding between N and Nb. Providing a carbon support surface NC 304 comprising atomically dispersed atoms 302 allows for use of a smaller amount of the starting material comprising the metal atoms (e.g., Nb).

It is further noted that even though an atomic level dispersion of metal atoms within the NC 304 powder is emphasized, the synthesized material comprising ADC 120, in addition to metal atoms dispersed at an atomic level (e.g., Nb atoms 302), may also have clusters comprising more than one metal Nb atom, and the clusters may grow into a few nanometers or even tens of nanometer particles. According to some embodiments as disclosed herein, using the disclosed methods, an area on the graphitic carbon support NC 304 comprising atomically dispersed niobium atoms 302 may be greater than an area on the graphitic carbon support NC 304 comprising clusters of more than one niobium atom such that atom-utilization efficiency is increased and amounts of the Nb containing metal salts may be lessened. In some embodiments, using the disclosed methods, an area on the graphitic carbon support NC 304 comprising atomically dispersed niobium atoms 302 may be less than an area on the graphitic carbon support NC 304 comprising clusters of more than one niobium atom.

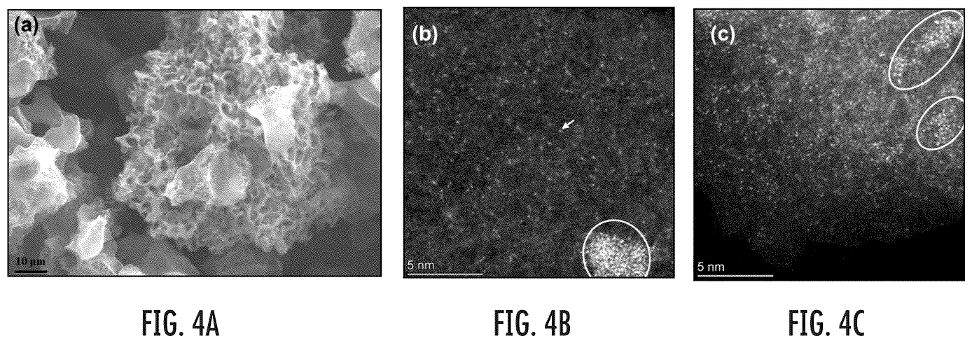

Electron microscopic images of Nb—N—C powder 120 is shown in FIGS. 4(a)-(c). An SEM image of synthesized Nb-ADC/NC catalyst powder 120 using the disclosed one-step method is shown in FIG. 4(a), revealing its microstructure and surface morphology. The derived graphitic carbon support from pyrolysis exhibits a hierarchical porous architecture, which is beneficial for the exposure of abundant Nb active sites as well as electrolyte mass transfer. Based on EDS/EDX (Energy Dispersive X-ray Spectrometer) analysis of the ADC 120 sample, even though no obvious metallic nanoparticles (e.g., Nb atoms 302) or clusters were observed, a strong Nb signal can still be detected, indicating the presence of Nb atoms 302. Atomic-scale microscopic imaging (High-angle annular dark-field scanning transmission electron microscopy, HAADF-STEM) are shown in FIGS. 4(b) and 4(c). This imaging was utilized to observe the distribution of individual, or very small numbers of, Nb atoms 302. The randomly dispersed bright spots in the images indicate the presence of Nb atoms 302 on the carbon surface NC 304. In some instances, aggregation of multiple individual Nb atoms 302 were observed, which might be the remains of Nb nanoparticles 302 after acid leach. In the images, the individual white dots are single Nb atoms 302, while the circled areas indicate larger aggregations of clusters, or numerous Nb atoms 302.

X-ray photoelectron spectroscopy (XPS) study (shown, for example, in FIGS. 5(a) and 5(b)) further confirms the elements in the sample. FIG. 5(a) illustrates a survey spectrum showing the elements. As shown in FIG. 5(a), the ADC 120 has Nb, O, N, and C elements, and Nb has an atomic concentration of ˜0.5 at %. The XPS Nb 3d spectra and its peak fitting of ADC 120 is displayed in FIG. 5(b), which splits into two peaks assigned to Nb 2p 5/2 (207.5 eV) and Nb 3d 3/2 (210.3 eV) and well match the +5-valence state of Nb.

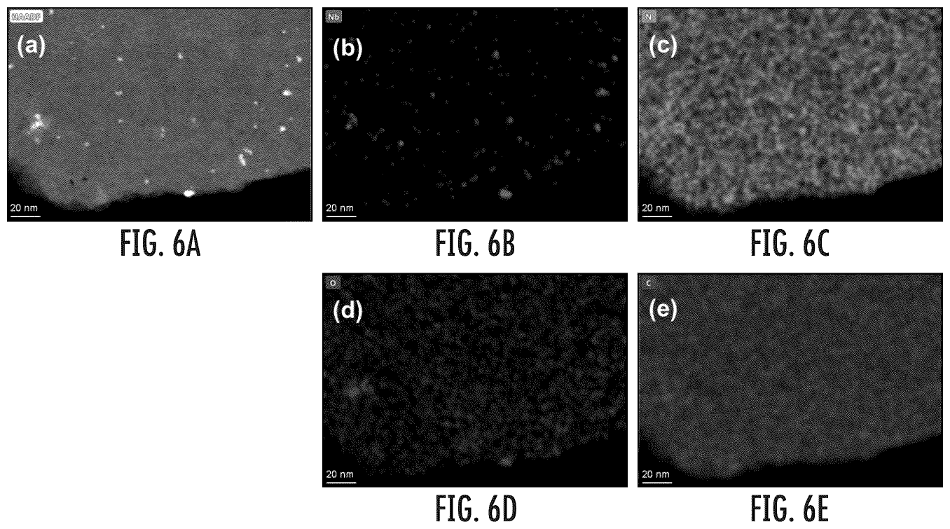

HAADF-STEM coupled Electron Energy Loss Spectroscopy (EELS) study further reveals elemental information at the nanometer scale, as shown in FIG. 6(a)-6(e). FIG. 6(a) shows the mapping area (as a HADDF-STEM image). In the mapping area, the carbon host (shown in FIG. 6(e)) contains uniformly distributed N elements (shown in FIG. 6(c)) and uniformly distributed O elements (shown in FIG. 6(d), with dispersed Nb atoms uniformly distributed on it (shown in FIG. 6(b). Thus, EELS spectra mapping indicates uniform distribution of Nb atoms on C host (e) that is doped with N and O.

FIGS. 7(a)-7(g) show the ORR performance and OER performance of different catalysts to evaluate the performance of ADC 120. To evaluate the ORR performance of the catalysts, linear sweep voltammetry (LSV) was conducted in 0.1 M KOH using a rotating disk electrode (RDE). The ORR performance of ADC 120 surpasses that of commercial Pt/C (Pt 20 wt %), self-made Fe—N—C (Fe single atom on N-doped carbon) derived from ZIF-8, and N-doped carbon in all aspects. This superior performance is attributed to the nitrogen and/or oxygen-coordinated Nb atoms 302 anchored on the porous carbon support NC 304, which optimize the local electronic structure and enhance the ORR performance. As shown in FIG. 7(a) (which shows the ORR LSV curves for the four catalysts (ADC 120, Fe—N—C, Pt—C, N—C)), the ADC 120 exhibits the best ORR activity with an onset potential (Eonset) of 1.05 V, a half-wave potential (E½) of 0.89 V, and a limiting current density (JL) of 6.31 mA/cm², all of which are higher than those of Pt/C (0.98 V, 0.86 V, and 5.26 mA/cm²) and Fe—C synthesized using the ZIF-8 templated method, which has been known as an excellent ORR catalyst.

Furthermore, as indicated in FIG. 7b (which shows corresponding Tafel plots), the ADC 120 achieves the minimum Tafel slope of 36.71 mV/dec compared to Fe-C (49.93 mV/dec), Pt/C (71.42 mV/dec), and pristine ONC (209.48 mV/dec). A smaller Tafel slope indicates faster reaction kinetics.

FIG. 7(c) shows ORR polarization curves of the ADC 120 from 400 to 1600 revolutions per minute (rpm), and FIG. 7(g) shows Koutecký-Levich (K-L) plot of the ADC 120 to analyze ORR kinetics on rotating disk electrodes (RDE). The increase in current density with increasing rotation rate (see FIG. 7(c)) and the corresponding K-L plots exhibiting a linear relationship (see FIG. 7(g)) suggest that the ORR process catalyzed by the ADC 120 is a first-order reaction with good kinetics. The number of ORR transferred electrons, calculated using the K-L equation, is approximately 4.0, indicating the reaction has good four-electron selectivity.

The synthesized ADC 120 features a hierarchical porous structure that provides abundant transport channels for O₂ diffusion and electrolyte infiltration, as well as numerous active sites for charge transfer reactions.

To evaluate the OER performance of the catalysts, linear sweep voltammetry (LSV) was conducted in O₂-saturated 0.1 M KOH using a rotating disk electrode (RDE). As shown in FIG. 7(d) (which shows the OER LSV curves for ADC 120, IrO₂/C, Fe—NC, and ONC), benchmark commercial IrO₂/C, Fe—NC, and pristine ONC show limited improvement in OER performance, whereas the ADC 120 demonstrates a significant enhancement in OER catalytic activity. ADC 120 achieves a lower onset potential (Eonset) of 1.49 V and a potential at 10 mA/cm²(Ej=10) of 1.54 V, surpassing the performance of commercial IrO₂/C (1.54 V and 1.58 V, respectively). FIG. 7(e) shows the corresponding Tafel plots to the LSV curves of FIG. 7(d). The Tafel slope of ADC 120 is calculated to be 37.81 mV/dec, which is lower than that of Fe—NC (65.68 mV/dec), IrO2/C (95.51 mV/dec), and NC (246.92 mV/dec) (FIG. 4(e)).

FIG. 7(f) shows the overall LSV curves of ORR and OER. The potential gap (ΔE=Ej=10−E½) is used to evaluate bifunctional catalytic activity, with smaller values indicating higher charge-discharge efficiency. As indicated in FIG. 7(f), ADC 120 exhibits the smallest ΔE of 0.65 V, compared to Pt/C+IrO₂/C (0.72 V), demonstrating exceptional bifunctional catalytic performance.

In some embodiments, to fabricate the ADC 120 coated air-electrode 104, ADC 120 ink may be prepared by thoroughly mixing ADC 120 powder (according to any of the embodiments discussed above), deionized water, isopropanol, and Nafion ionomer. For example, in some embodiments, 10 mg of catalyst powder, 490 μL of deionized water, 490 μL of isopropanol, and 20 μL of Nafion ionomer may be thoroughly mixed through sonication for 30 minutes. A Zn-air battery 100 may be assembled with a polished zinc plate as the negative electrode 102, 6 M KOH+0.2 M Zn(CH3COO)2 as the alkaline electrolyte 106, and an air electrode as the positive electrode 104. In some embodiments, the air electrode comprises a gas diffusion layer (hydrophilic carbon cloth), nickel foam as a current collector, and a catalytic layer (hydrophobic carbon paper), which may be prepared using a roller-press method. In some embodiments, the catalyst ink may be applied to the catalytic layer. For example, in some embodiments, 100 μL of the ADC 120 ink may be carefully applied to the catalytic layer and dried at 120° C. for 2 hours. The effective area of the catalytic layer may be approximately 1 cm² with a loading capacity of about 1.0 mg/cm².

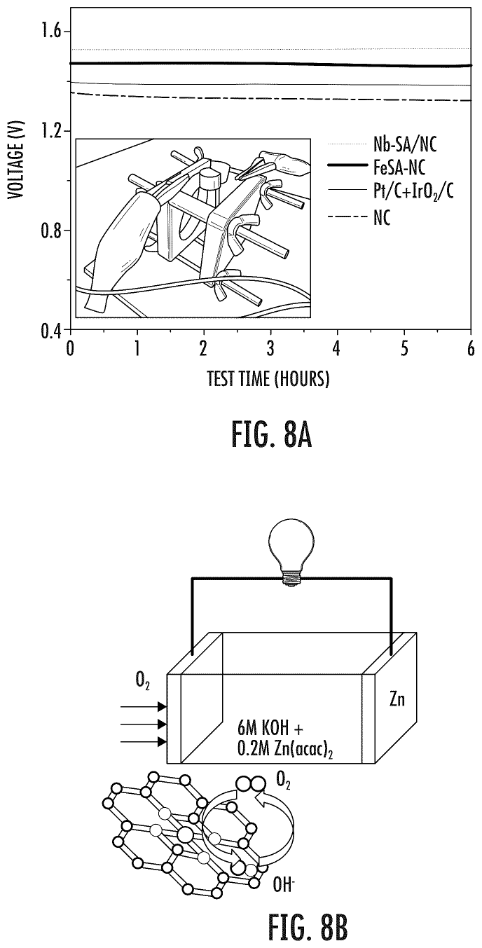

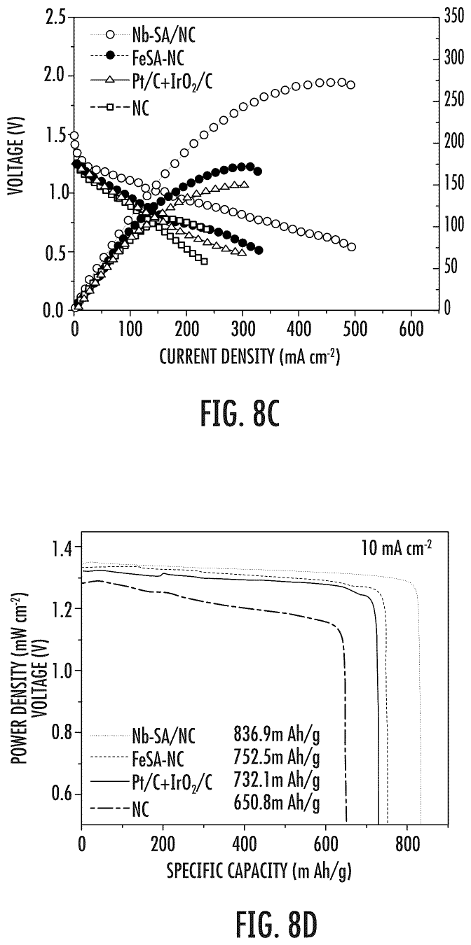

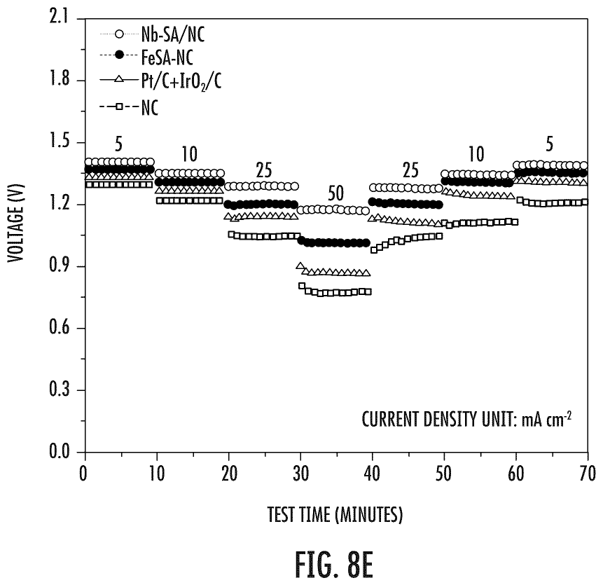

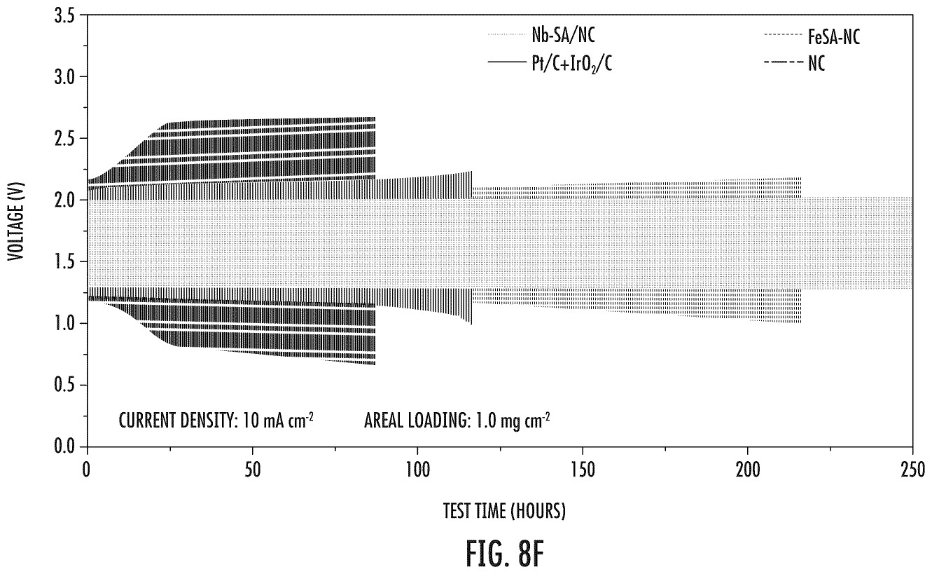

To demonstrate the actual performance and application in metal-air batteries (e.g., ZAB 100), ADC 120 was employed as the air positive electrode catalyst in aqueous rechargeable Zinc-Air batteries (ZABs) 100, with the commonly used mixture of Pt/C and IrO2/C serving as the control group. FIG. 8(a) shows open-circuit voltages of zinc-air batteries coupled with different catalysts. As shown in FIG. 8(a), the ZAB 100 with ADC 120 possesses an open circuit voltage of 1.52 V, which is higher than that of Pt/C+IrO₂/C (1.45 V). The voltage remains stable for more than 6 hours without any significant decrease, suggesting trivial self-discharging. FIG. 8(b) shows a schematic configuration of an aqueous Zinc-air battery 100 with ADC 120 as a bifunctional catalyst to boost the ORR and OER kinetics.

FIG. 8(c) shows LSV polarization profiles at a scan rate of 10 mV s−1 and the corresponding power densities curves. In FIG. 8(c), the peak power density of the ZAB 100 assembled with ADC 120 reaches 272.9 mW/cm², surpassing that of Pt/C+IrO2₂/C (151.1 mW/cm²). FIG. 8(d) shows a Zn-mass-normalized specific capacities comparison at a current density of 10 mA cm−2. At a current density of 10 mA/cm², the ZAB 100 based on ADC 120 achieves a high specific capacity of 836.9 mAh/g, compared to 732.1 mAh/g for Pt/C+IrO₂/C (see FIG. 8(d)). FIG. 8(e) shows a discharge rate performance comparison of the Zn-air batteries 100 at current densities of 5, 10, 25, and 50 mA cm−2. The average discharge voltage platform for ADC 120 and Pt/C+IrO₂ is 1.32 V and 1.28 V, respectively. Furthermore, the ZABs based on ADC 120 exhibit higher discharge voltages than those based on Pt/C+IrO₂ at various current densities (see FIG. 8(e)), indicating superior rate performance. In addition, it is noted that the ZAB 100 with ADC 120 has better performance than Fe—NC catalyst. FIG. 8(f) shows galvanostatic cycling tests of the Zn-air batteries operating at current densities of 10 mA cm−2 with each cycle lasting for 15 min. In the galvanostatic charge/discharge cycling tests (see FIG. 8(f)), the ZAB 100 with ADC 120 exhibits the smallest overpotential and the best stability/sustainability. After 250 hours with each cycle lasting for 15 min, there is even no discernable change in the charge/discharge voltage for the ZAB 100 with ADC 120, while all others started to degrade.

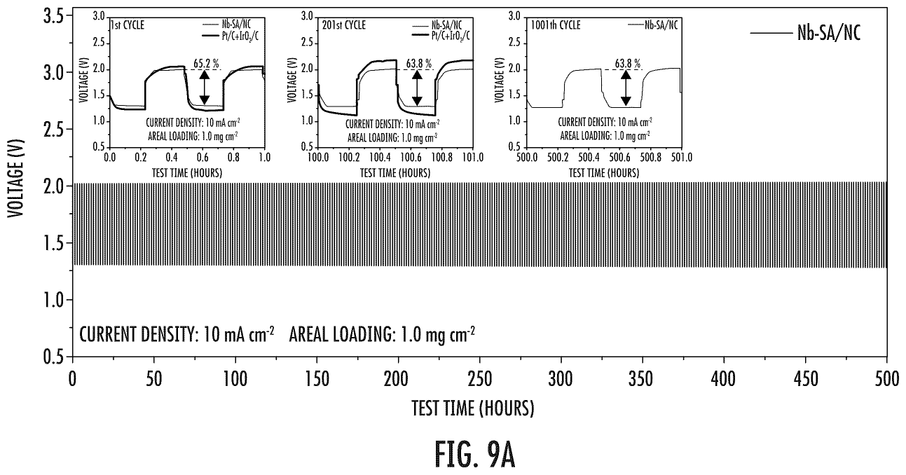

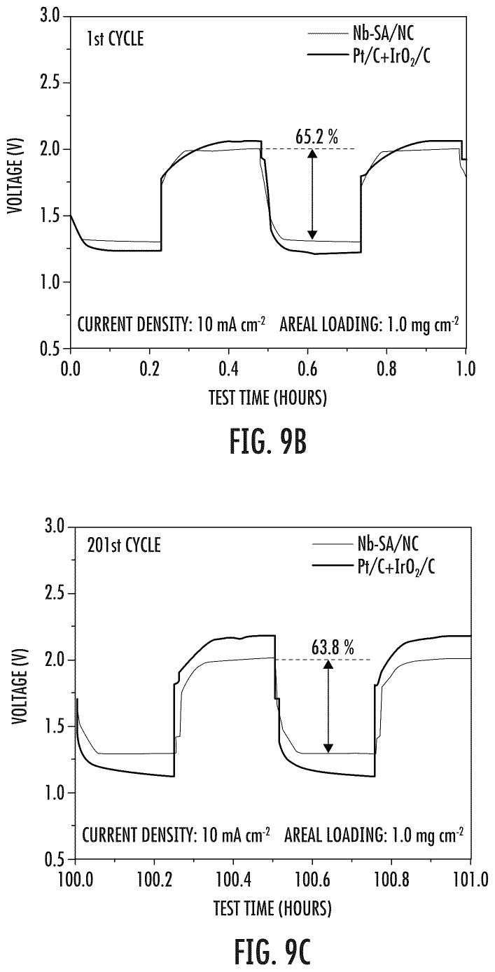

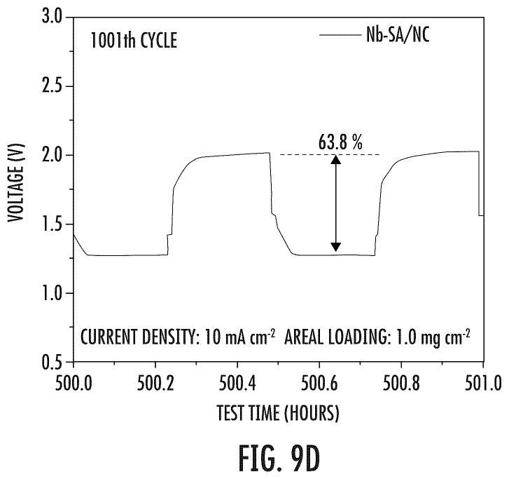

FIGS. 9(a)-9(d) shows long-term galvanostatic cycling tests of the Zn-air batteries 100 assembled with ADC 120 operating at current densities of 10 mA cm⁻² with each cycle lasting for 15 min. The stability/sustainability of ADC 120 was further tested for up to 500 hours as the positive electrode 104 atomically dispersed catalyst 120 of ZAB 100 by repeatedly charging and discharging at a current density of 10 mA/cm² for 15 minutes. As shown in FIGS. 8f and 9(a)-9(d), the ZAB 100 based on ADC 120 exhibits excellent cycling stability and extended lifetime compared to other catalyst materials. As shown in FIG. 9(b), the ZAB 100 with ADC 120 possesses an initial discharge-charge hysteresis of 0.69 V and a round-trip energy efficiency of 65.2%. As shown in FIG. 9(c), after 200 cycles (100 hours), the polarization remains stable, and the discharge efficiency only slightly decreases to 63.8%, which is significantly better than the battery with Pt/C+IrO₂/C catalyst (200 cycles, 1.04 V, 49.7%). As shown in FIG. 9(d), the excellent cycling performance of ADC 120 is retained in the tested 500 hours (1000 cycles), with only a slight increase in the charge-discharge hysteresis to 0.75 V and a minor decrease in discharge efficiency to 62.3% at the 1001st cycle. This outstanding charge-discharge cycle stability of ZAB 100 indicates that the ADC 120 has very stable ORR/OER catalytic activity and good structural integrity in the alkaline electrolyte 106.

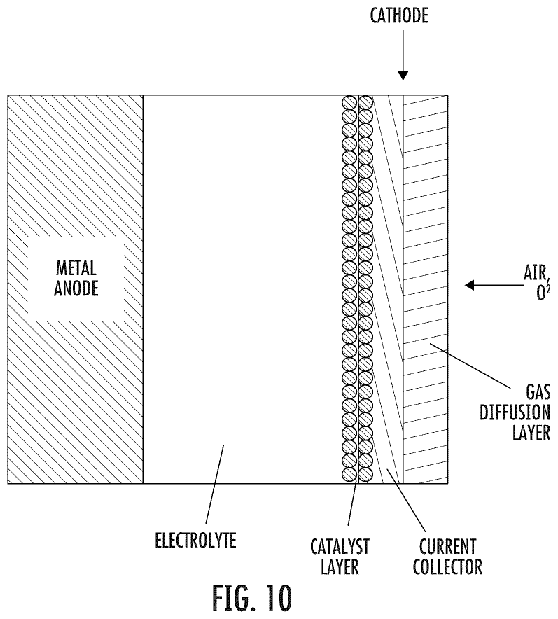

FIG. 10 illustrates a metal-air battery 1000 according to some embodiments of the disclosure. In some embodiments, the metal-air battery 1000 comprises a positive electrode 1004 having multiple layers, including the disclosed catalyst coated layer 1020 (e.g., ADC 120).

Depicted is a metal negative electrode 1002, which in some embodiments may comprise zinc, iron, magnesium, aluminum or lithium, and alloys formed therefrom. Further shown is an electrolyte 1006 which may comprise an aqueous or organic liquid, dependent upon the material selected for the metal negative electrode and compatibility with the Nb based ADC, like the disclosed ADC 120. According to some embodiments, an alkaline electrolyte, such as KOH and Zn(CH3COO)2 may be used as the electrolyte 1006. The electrolyte 1006 may have a range of concentrations, such as from 4 to 8 M KOH, or about 6 M KOH, and from 0.1 M to 0.4 M Zn(CH3COO)2 or about 0.2 M Zn(CH3COO)2.

The positive electrode 1004 is depicted as a multilayer structure, comprising a gas diffusion layer 1024, a current collector layer 1022 and a catalyst layer 1020. The gas diffusion layer 1024 may comprise a carbon paper, carbon cloth, or other porous carbon material and is exposed to the outside environment such that air and the active material, oxygen, may pass through the gas diffusion layer 1024. In some embodiments, the gas diffusion layer 1024 may comprise a hydrophilic carbon paper.

The current collector 1022 is disposed between the gas diffusion layer 1024 and a catalyst layer 1020 (e.g., ADC 120), and transfers electrons to and from the catalyst layer 1020. The current collector 1022 may comprise a metal mesh, foil or foam formed of nickel, copper, aluminum, titanium or in some embodiments stainless steel. The catalyst layer 1020 may be disposed adjacent the current collector 1022 and in contact with the electrolyte 1006. The catalyst layer 1020 as part of the positive electrode 1004 may comprise atomically dispersed niobium atoms 302 and a nitrogen-doped graphitic carbon support NC 304 formed as ADC 120. According to some embodiments, the atomically dispersed niobium atoms 302 may be dispersed on at least a portion of the nitrogen-doped graphitic carbon support NC 304, and as such, at least a portion of the catalyst coated layer 1020 may be characterized by an absence of niobium clusters as confirmed by high-angle annular dark-field scanning transmission electron microscopy (HAADF-STEM). The atomically dispersed niobium atoms 302 may be bonded to, or anchored by, nitrogen atoms within the nitrogen-doped graphitic carbon support NC 304 such that the niobium atoms 302 are disposed in a fixed location on the carbon support NC 304 at temperatures of about 600° C. and less. According to some embodiments, a nitrogen atom concentration may be the same as, or substantially the same as, a carbon atom concentration in the nitrogen-doped graphitic carbon support NC 304. According to further embodiments, an oxygen atom concentration may be substantially the same as, or less than, a nitrogen atom concentration in the nitrogen-doped graphitic carbon support NC 304. In some embodiments, at least a portion of the catalyst coated layer 1020 further comprises clusters of more than one niobium atom disposed on the support NC 304, wherein the clusters are 20 nanometers (nm) or less in size.

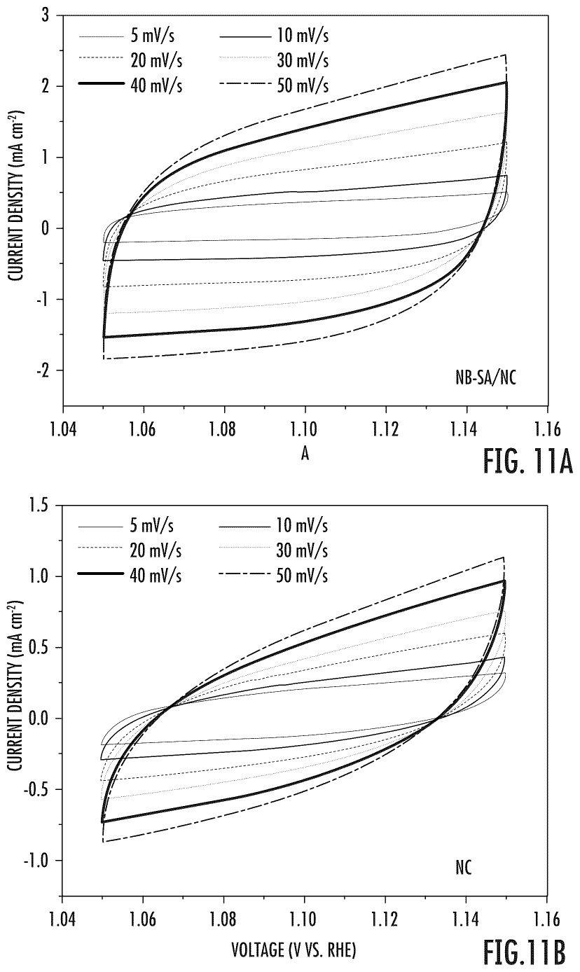

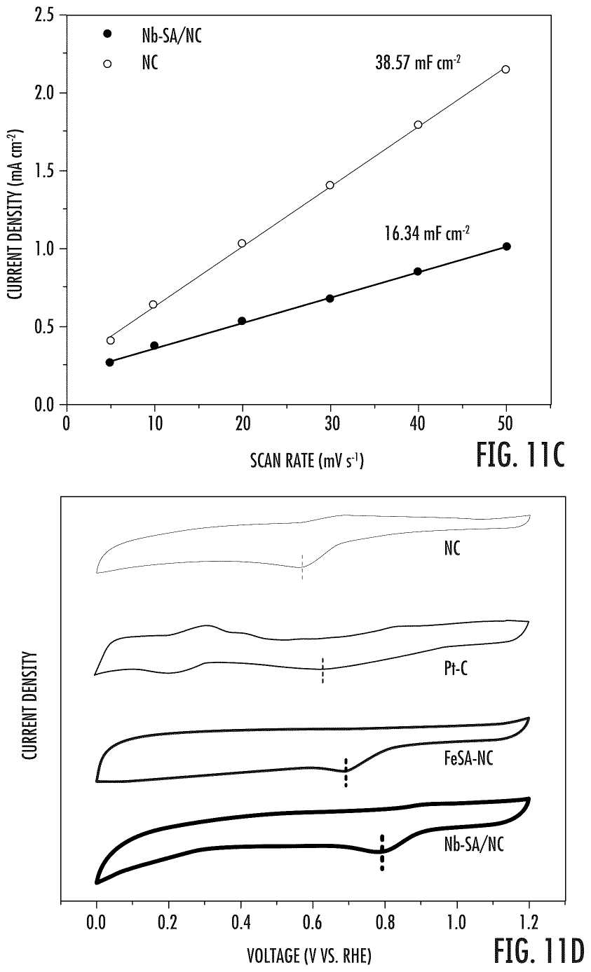

As depicted in FIGS. 11(a)-11(d), the electrochemical active surface area (ECSA) was evaluated by comparing the double-layer capacitance (Cdl) of the ADC 120 with pristine NC. A higher Cdl generally corresponds to a larger ECSA. By recording electrochemical cyclic voltammetry (CV) curves at various scan rates in the non-Faraday region (FIG. 11(a) and 11(b)), the Cdl was determined by fitting the slopes of the current density values at 1.15 V versus the scan rates (FIG. 11(c)). ADC 120 exhibited a significantly higher Cdl (38.57 mF cm−2) compared to pristine NC (16.34 mF cm−2), indicating a larger electrochemical active area in the carbon matrix of ADC 120, making it more advantageous for the ORR catalytic process.

Typically, electrocatalysis occurring at the interface of electrolyte and electrode combines the adsorption/desorption of the ions and the diffusion of the ions. The presence of Nb single atoms 302 coordinated with Nx on the carbon structure are inclined to interact with the ionic ligands in the KOH environment in this voltage range. This enhances the adsorption/desorption of the ions on the surface for the ADC 120 compared to the pristine NC counterpart. The introduction of Nb atoms 302 alters the electronic structure of the carbon surface NC 304, improving ion contact and lower electronic resistance, as shown by the flattened shape of CV profiles. The CV curves describing the overall ORR process in O2-saturated alkaline electrolytes are depicted in FIG. 11(d). All catalysts displayed reduction peaks in O₂-saturated alkaline electrolytes, but the ADC 120 exhibited the most positive cathodic peak potential, indicating the most superior ORR performance compared to the other catalysts.

While this disclosure provides example methods to synthesize the ADC 120, one skilled in the art would appreciate there are other methods and variations to effectively synthesize the ADC 120.

Detailed embodiments of the present disclosure are included herein. It is to be understood that the disclosed embodiments are merely exemplary of the disclosure that may be embodied in various forms. Therefore, specific structural and functional details disclosed herein are not to be interpreted as limits, but merely as a basis for teaching one skilled in the art to employ embodiments of the present disclosure. The specific examples given herein will enable the disclosure to be better understood. The examples, however, are given merely by way of guidance and do not imply any limitation.

It will be understood that implementations of the metal-air battery include but are not limited to the specific components disclosed herein, as virtually any components consistent with the intended operation of various metal-air batteries may be utilized. Accordingly, for example, it should be understood that, while the drawings and accompanying text show and describe particular metal-air battery implementations, any such implementation may comprise any shape, size, style, type, model, version, class, grade, measurement, concentration, material, weight, quantity, and/or the like consistent with the intended operation of metal-air batteries.

The concepts disclosed herein are not limited to the specific metal-air battery shown herein. For example, it is specifically contemplated that the components included in particular metal-air batteries may be formed of any of many different types of materials or combinations that can readily be formed into shaped objects and that are consistent with the intended operation of the metal-air battery. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, metal-air batteries may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular metal-air battery implementations, it should be readily apparent that a number of modifications may be made without departing from the spirit thereof and that these implementations may be applied to other implementations disclosed or undisclosed. The presently disclosed metal-air batteries are, therefore, to be considered in all respects as illustrative and not restrictive.

Many additional implementations are possible. Further implementations are within the CLAIMS.

What is claimed is:

1. A metal-air battery, the metal-air battery comprising:
a negative electrode;
an electrolyte, and
a positive electrode comprising a catalyst coated layer comprising niobium atoms and a nitrogen-doped graphitic carbon support, wherein the niobium atoms are atomically dispersed on the nitrogen-doped graphitic carbon support.

2. The metal-air battery of claim 1, wherein at least half of the nitrogen-doped graphitic carbon support comprises a single graphene layer.

3. The metal-air battery of claim 1, wherein the niobium atoms are bonded to nitrogen atoms within the nitrogen-doped graphitic carbon support.

4. The metal-air battery of claim 3, wherein the nitrogen-doped graphitic carbon support further comprises oxygen atoms bonded to the niobium atoms.

5. The metal-air battery of claim 1, wherein the nitrogen-doped graphitic carbon support exhibits a hierarchical porous structure.

6. The metal-air battery of claim 1, wherein the catalyst coated layer is configured to catalyze both oxygen reduction reactions (ORR) and oxygen evolution reactions (OER).

7. The metal-air battery of claim 1, wherein the negative electrode comprises zinc, iron, magnesium, aluminum, or lithium.

8. The metal-air battery of claim 1, wherein the electrolyte comprises an alkaline electrolyte.

9. The metal-air battery of claim 8, wherein the electrolyte comprises KOH.

10. The metal-air battery of claim 1, wherein the nitrogen-doped graphitic carbon support comprises a nitrogen atom concentration which is substantially the same as a carbon atom concentration.

11. The metal-air battery of claim 1, wherein an area on the graphitic carbon support comprising atomically dispersed niobium atoms is greater than an area on the graphitic carbon support comprising clusters of more than one niobium atom.

12. A positive electrode for a metal-air battery, the positive electrode comprising:
a catalyst coated layer comprising niobium atoms and a nitrogen-doped graphitic carbon support,
wherein the niobium atoms are atomically dispersed on the nitrogen-doped graphitic carbon support.

13. The positive electrode of claim 12, wherein at least a portion of the catalyst coated layer comprises clusters of more than one niobium atom dispersed on the nitrogen-doped graphitic carbon support, wherein the clusters are 20 nanometers (nm) or less in size.

14. The positive electrode of claim 13, wherein a surface area of the graphitic carbon support comprising atomically dispersed niobium atoms is greater than a surface area of the graphitic carbon support comprising clusters of more than one niobium atom.

15. The positive electrode of claim 12, wherein the niobium atoms are bonded to nitrogen sites within the nitrogen-doped graphitic carbon support.

16. The positive electrode of claim 12, wherein the catalyst coated layer catalyzes both oxygen reduction reactions (ORR) and oxygen evolution reactions (OER).

17. The positive electrode of claim 12, wherein a nitrogen atom concentration is substantially the same as a carbon atom concentration in the nitrogen-doped graphitic carbon support.

18. The positive electrode of claim 12, wherein the niobium atoms are in a fixed location on the nitrogen-doped graphitic carbon support.

19. The positive electrode of claim 12, wherein the nitrogen-doped graphitic carbon support comprises PCN.

20. An electrode for a metal-air battery, the electrode comprising:
a gas diffusion layer;
a current collector, and
a catalyst coated layer, wherein the catalyst coated layer comprises a nitrogen-doped graphitic carbon support and atomically dispersed niobium atoms disposed on at least a portion of a surface of the nitrogen-doped graphitic support.
